(19) United States
(12) Patent Application Publication
(10) Pub. No.: US 2006/0206431 A1
(43) Pub. Date: Sep. 14, 2006

(54) System and method allowing the purchase of multimedia content from a portable device previously dispensed in connection with an entertainment event

(75) Inventors: Deborah Scott, Pleasant Hill, CA (US); Erica Douglass, San Jose, CA (US)

Correspondence Address: Starkweather and Associates, Suite 200, 9035 South 1300 East, Sandy, UT, 84094, US

(73) Assignee: Light Rhythms, LLC

(21) Appl. No.: 11/077,937

(22) Filed: Mar. 11, 2005

(51) Int. Cl. G06F 17/60

(52) U.S. Cl. 705/52

(57) ABSTRACT

A novel multimedia content distribution method at least includes: a) providing a portable light emission device adapted to be carried by a user, and adapted to be activated according to a remotely received signal, so that the light of the device acts as a pixel of a remotely generated display during the attendance of the user at an entertainment event; b) storing in memory subsumed by the light emission device, multimedia content; c) coupling the device via a link to a computer; d) connecting the computer to an Internet website; e) via the Internet website, allowing the user to purchase multimedia content stored on the light emission device; f) transferring multimedia content from the light emission device to the computer; and g) upon the purchase of the multimedia content, providing from the Internet website, an unlocking code to the computer to allow the normal functioning of the purchased multimedia content.

### FIELD OF THE INVENTION

The present invention generally relates to the purchase and distribution of multimedia content, and specifically relates to electronic means of accomplishing the same.

### DESCRIPTION OF THE RELATED ART

U.S. patent application Ser. No. 10/985,399, filed Nov. 9, 2004 for “Apparatus, System and Method for Controlling Remote Lighting Devices,” discloses a method for enhancing the experience of audience members at concerts, sporting events, and the like.

In the aforementioned patent application, audience members are provided with special hardware devices that nominally include light emitters, receivers for receiving transmitted signals for activating the light emitters, and means for recording the participation in events, as well as the actions of the device during the events.

A master transmitter (or group of transmitters in the alternative), sends light activation signals throughout the event viewing area accompanied by the addresses of individual light emission devices, or groups of devices to which the light activation signals pertain. In essence, each light emission device represents a pixel associated with an individual user that can be turned on or off as part of a large display encompassing the light emission devices (and hence, the audience members).

A system utilizing devices disclosed in the aforementioned U.S. Patent Application may be modified to provide for additional sales and revenue by allowing a user who has previously attended an entertainment event to conveniently purchase multimedia content such as DVD files, CD files, and the like.

It is therefore an object of the present invention to provide a mechanism for allowing the user to purchase multimedia content which can be reproduced in the form of DVD movies, CD files, MPEG3 files and the like. It is further an object of the present invention to allow the multimedia content to be novelly stored directly on the aforementioned devices, and to allow the multimedia content to be purchased from a merchant supplying the aforementioned devices, and then transferred to a computer or other storage mechanism. And, an additional object of the present invention is to provide adequate safeguards against the unauthorized use of multimedia content stored on the aforementioned device, when the multimedia content has not been purchased.

### SUMMARY OF THE INVENTION

The present invention has been developed in response to the present state of the art, and in particular, in response to the problems and needs in the art that have not yet been fully solved by currently available approaches. Accordingly, the present invention has been developed to provide a multimedia content distribution method at least including: a) providing a portable light emission device adapted to be carried by a user, and adapted to be activated according to a remotely received signal, so that the light of the device acts as a pixel of a remotely generated display during the attendance of the user at an entertainment event; b) storing in memory subsumed by the light emission device, multimedia content; c) coupling the device via a link to a computer; d) connecting the computer to an Internet website; e) via the Internet website, allowing the user to purchase multimedia content stored on the light emission device; f) transferring multimedia content from the light emission device to the computer; and g) upon the purchase of the multimedia content, providing from the Internet website, an unlocking code to the computer to allow the normal functioning of the purchased multimedia content.

The present invention has also been developed to provide a multimedia content distribution system at least including: a portable light emission device adapted to be carried by a user, and adapted to be activated according to a remotely received signal, so that the light of the device acts as a pixel of a remotely generated display during the attendance of the user at an entertainment event; the light emission device further including memory storing multimedia content; a link adapted to couple the device to a computer; and an Internet website adapted to couple to the computer, and adapted to allow the user to purchase multimedia content stored on the light emission device; wherein the light emission device is further adapted to transfer multimedia content to the computer, and the Internet website is adapted to provide an unlocking code to the computer to allow the normal functioning of the purchased multimedia content.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a schematic diagram of the light emission devices and other hardware constructed according to the present-inventive multimedia content distribution method;

FIG. 2 illustrates a schematic diagram of the components of the present-inventive multimedia content distribution system; and

FIG. 3 illustrates a flowchart detailing the general steps in the present-inventive multimedia content distribution method.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

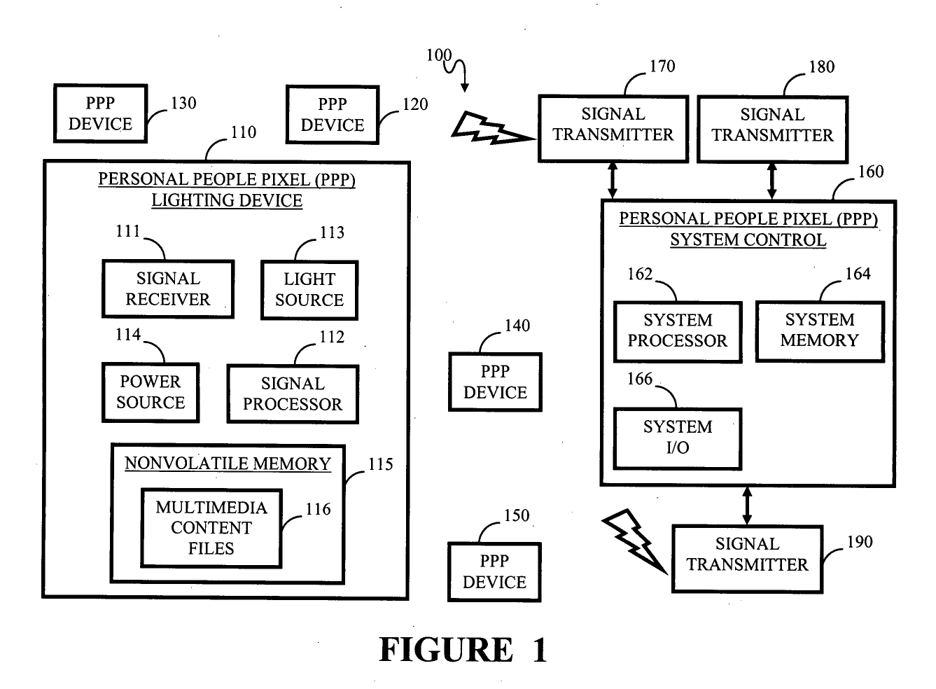

Turning to FIG. 1, a system 100 discloses novel light emission devices (110, 120, 130, 140 and 150), also referred to as “personal people pixel light emission” or “PPP” devices utilized by users who have attended entertainment events such as concerts, sporting contests, parades, etc., wherein the event actively supports the use of the devices, as more fully described in the aforementioned U.S. patent application Ser. No. 10/985,399. The system 100 also includes at least one personal people pixel system control unit 160, responsible for the control (i.e., directing the “on” and “off” states”) of the special light emission devices.

The system control 160 nominally includes a system processor 162 responsible for the overall operation of the unit, system memory for storing a variety of information, including the aforementioned large-scale display patterns, and a system input/output 166. Several signal transmitters 170, 180 and 190 broadcast pixel activation information (received from the system control) to the PPP devices.

The PPP devices can each contain a signal receiver 111 for receiving transmitted information such as pixel activation information, a signal processor 112 for processing the received signal, the aforementioned light source 113 for illuminating an area according to a master pattern, and a power source 114. Novel to the present application for letters patent is nonvolatile memory 115 specially adapted to store multimedia content files 116. Flash memory serves as the nonvolatile memory in the preferred embodiment, although those skilled in the art will appreciate that other forms of nonvolatile memory are also compatible with the teachings of the present invention.

The present-inventive, device, system and method, distribute PPP devices to entertainment event participants, in which multimedia content has been previously stored on the devices. The multimedia content is of a variety that would be of interest to consumers. The multimedia content can have a special relationship to the event attended by the user, or it can be more general. For example, PPP device users who have just attended a concert by a certain musical group might be given the opportunity to purchase a just-released compact disc (CD) album in which the aforementioned musical group is the artist of record. Or, the PPP device users may be given the opportunity to purchase a digital video disc (DVD) formatted movie that was advertised at the event. The multimedia content may also be more general, including various digital audio-visual files, audio files (including those in various formats such as MPEG3), and video files. Those skilled in the pertinent arts will appreciate that many other forms of multimedia content can be stored on the PPP devices for purchase by a user.

The multimedia content is stored directly on the PPP device so that it can be transferred directly to the user's computer or other digital storage device once the multimedia content has been properly purchased. This obviates the need for downloading multimedia content from the Internet.

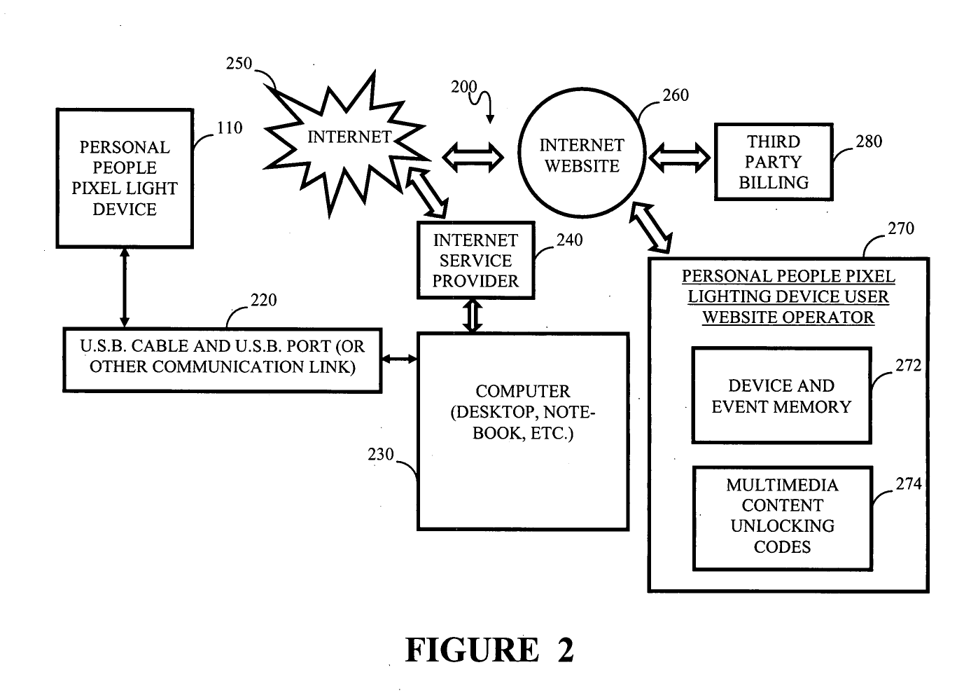

The system 200 in FIG. 2 illustrates the basic components used for the purchase and transfer of multimedia content according to the present invention. In the example, a PPP device 10 is connected to a computer 230 via a USB cable and USB port (220). Those skilled in the art to which the present invention pertains will appreciate, however, that the device 110 may be linked to the computer 230 using other approaches such as wireless communication links, and other well-known ports, such as serial ports. Also, the computer 230 is a generic computing device, which includes, for example, desktop and notebook computers, and the like, as well as personal data assistants (PDAs) capable of Internet-based communication.

The computer 230 connects to the Internet 250 via an Internet Service Provider 240, and to an Internet website 260 under the control of a website operator 270. The website operator 270 is identified symbolically as a “personal people pixel lighting device user website operator.” The basic components utilized by the website operator 270 include a device and event memory 272, for tracking PPP devices and the presence at predefined entertainment events, and a multimedia content unlocking code generator 274. A third party billing agent 280 handles financial transactions that are part of the purchase process. Such financial transactions include credit card purchases.

Because the multimedia content is stored directly on the PPP devices, attempts at unauthorized use of multimedia content (i.e., when the multimedia content has not been purchased) is anticipated. To address this problem, the proper use of the multimedia content requires that the correct unlock codes be received before the multimedia content may viewed with normal functionality. Accordingly, lack of the correct unlocking codes renders the multimedia content non-viewable (or unperceivable to the user). Those skilled in the art will appreciate that many approaches to locking and then unlocking the multimedia content are possible given the teachings of the present invention.

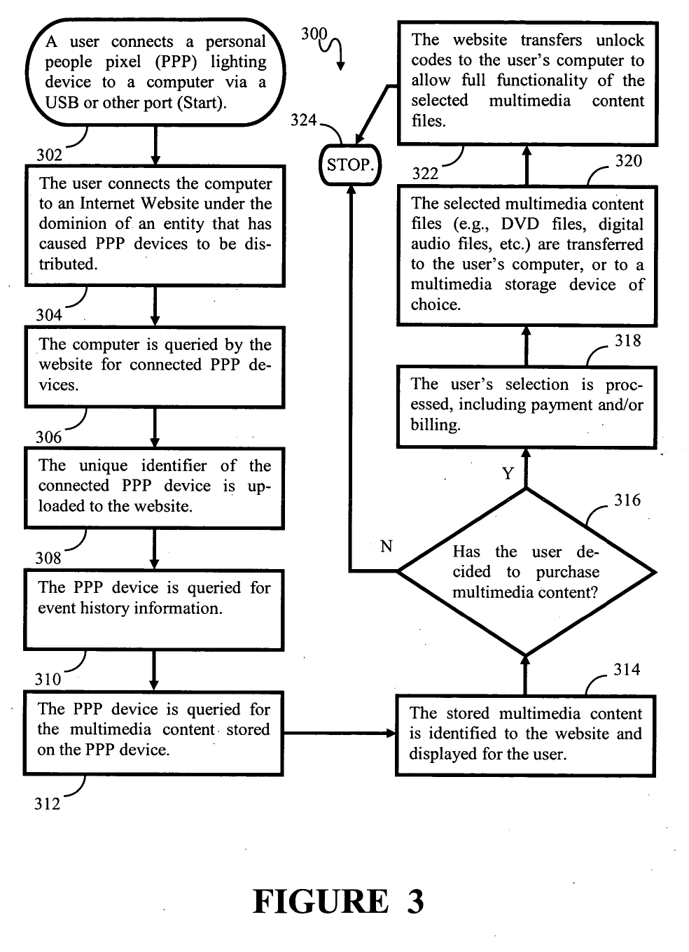

FIG. 3 illustrates a flowchart for a general algorithm 300 used to implement the present-inventive method for the purchase and distribution of multimedia content from a PPP device. To start the algorithm a user connects a PPP device to a computer (Step 302). In Step 304, the computer is connected to an Internet website on the World Wide Web under the dominion of a website operator responsible for allowing PPP device users to purchase embedded multimedia content.

The next step (306) queries the computer for connected PPP devices. The connected PPP device uploads a unique identifier to the website (Step 308). The website uses a database to match the unique identifier with the multimedia content known to be stored on the PPP device. Step 310, an optional step, also queries the PPP device for event history information stored by the PPP device as a result of the activities of the PPP device at a previous entertainment event.

Steps 312 and 314 formally identify the multimedia content stored on the PPP device and available for purchase. Discrepancies between the actual stored multimedia content and the expected multimedia content might indicate unauthorized device tampering, or problems with content tracking. As a matter of design choice, the proper course of action for such discrepancies can be included in the algorithm.

If the user decides to purchase stored multimedia content in a menu-driven process, the selection is processed, along with the necessary payment in Steps 316 and 318. If the user has not decided to purchase stored multimedia content, the algorithm jumps from Step 316 to the end (Step 324). Following Step 318, the purchased multimedia content files are transferred to the user's computer or an external storage device connected to the user's computer (Step 320). Finally, the unlock codes needed to properly reproduce the multimedia content for a viewer/listener are downloaded to the user's computer (Step 322).

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A multimedia content distribution method comprising:
a) providing a portable light emission device adapted to be carried by a user, and adapted to be activated according to a remotely received signal, so that the light of said device acts as a pixel of a remotely generated display during the attendance of said user at an entertainment event;
b) storing in memory subsumed by said light emission device, multimedia content;
c) coupling said device via a link to a computer;
d) connecting said computer to an Internet website;
e) via said Internet website, allowing said user to purchase multimedia content stored on said light emission device;
f) transferring multimedia content from said light emission device to said computer; and
g) upon the purchase of said multimedia content, providing from said Internet website, an unlocking code to said computer to allow the normal functioning of the purchased multimedia content.

2. The method of claim 1, wherein said memory is nonvolatile.

3. The method of claim 2, wherein said memory comprises flash memory.

4. The method of claim 1, wherein said multimedia content comprises digital audio information.

5. The method of claim 4, wherein said digital audio information comprises compact disc files.

6. The method of claim 4, wherein said digital audio information comprises MPEG3 files.

7. The method of claim 1, wherein said multimedia content comprises digital audio-visual information.

8. The method of claim 7, wherein said digital audio-visual information comprises digital video disc (DVD) files.

9. The method of claim 1, wherein at least a portion of said multimedia content has been advertised at said entertainment event.

10. The method of claim 1, wherein at least a portion of said multimedia content bears a commercial relationship to a performing entity at said entertainment event.

11. A multimedia content distribution system comprising:
a portable light emission device adapted to be carried by a user, and adapted to be activated according to a remotely received signal, so that the light of said device acts as a pixel of a remotely generated display during the attendance of said user at an entertainment event; said light emission device further comprising memory storing multimedia content;
a link adapted to couple said device to a computer; and
an Internet website adapted to couple to said computer, and adapted to allow the user to purchase multimedia content stored on said light emission device;
wherein said light emission device is further adapted to transfer multimedia content to said computer, and said Internet website is adapted to provide an unlocking code to said computer to allow the normal functioning of the purchased multimedia content.

12. The system of claim 11, wherein said memory is nonvolatile.

13. The system of claim 12, wherein said memory comprises flash memory.

14. The system of claim 11, wherein said multimedia content comprises digital audio information.

15. The system of claim 14, wherein said digital audio information comprises compact disc files.

16. The system of claim 14, wherein said digital audio information comprises MPEG3 files.

17. The system of claim 11, wherein said multimedia content comprises digital audio-visual information.

18. The system of claim 17, wherein said digital audio-visual information comprises digital video disc (DVD) files.

19. The system of claim 11, wherein at least a portion of said multimedia content has been advertised at said entertainment event.

20. The system of claim 11, wherein at least a portion of said multimedia content bears a commercial relationship to a performing entity at said entertainment event.
